(19) United States
(12) Patent Application Publication
(10) Pub. No.: US 2012/0304371 A1
(43) Pub. Date: Dec. 6, 2012

(54) BIDET APPARATUS

(75) Inventors: Erhan Duvencioglu, Istanbul (TR); Mustafa Manavoglu, Istanbul (TR)

(73) Assignee: ECZACIBASI YAPI GEREÇLERI SANAYI ve TI CARET ANONI M SIRKETI, Istanbul (TR)

(21) Appl. No.: 13/579,197

(22) PCT Filed: Jan. 20, 2011
(86) PCT No.: PCT/EP2011/050721

§ 371 Date: Aug. 15, 2012

(30) Foreign Application Priority Data
Feb. 17, 2010 (TR) 2010/01193

(51) Int. Cl. A61H 35/00

(52) U.S. Cl. 4/448

(57) ABSTRACT

A bidet apparatus has one main shell in the form of a tube; one bidet pipe provided in the main shell, which moves put from the main shell by moving in forward direction by water pressure exerted on its rear surface and which moves by means of pressure of spring within the main shell and water cut off. There is provided at least one cover, provided in front of the water outlet of the pipe, which is feed to the main shell by means of a hinge in the front portion of said shell and is opened by rotating after it is pushed by the bidet pipe that moves in forward direction.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

Present invention relates to bidet apparatus used in toilet bowls.

2. Description of Related Art Including Information Disclosed Under 37 CFR 1.97 and 37 CFR 1.98.

As known, nozzle bidets and bidet pipes, which said bidets are fixed to, are used in toilet bowls for the aim of cleaning. Bidets pipes are used for directing water coming from bidets towards inside of the toilet bowl and parts of the user's body to be cleaned. Bidets pipes, end parts of which usually extend towards inside of the toilet bowl, may sometimes get dirty. This is surely an undesired situation for the users due to both appearance and cleaning difficulties. Therefore, bidets are preferred to be movable and extend towards inside of the toilet bowl in line with instructions of user and to get back to its place within the toilet bowl after it is used. Accordingly, “bidet apparatus” is developed. In said apparatus, the bidet pipe comes out of its housing for only cleaning process and thus, outer surface of the bidet pipe, which is not easy clean, is kept clean. Moreover, keeping water outlet of bidet pipe clean is also important. In published patent application no. U.S. Pat. No. 5,287,566 of prior art, a bidet pipe having water outlet with cover is disclosed. Said pipe is immovable and only its outlet is kept clean thanks to the cover. The cover is opened to outside by water pressure and wafer may splash since the cover contacts with water during opening process.

Patent document with number DE 2646021 A1 discloses an under spray arrangement for toilet bowls and the like. Said arrangement comprises a cylindrical housing; a tube or pipe which is arranged in said housing and which is able to move in this housing; a sealing element attached to said tube; a first portion of said housing which surrounds said sealing element; a second portion of said housing which has larger diameter than the first one; at least one hole in the tube for receiving water and at least one spring that moves the tube. Similarly, patent document with number TR 200103593 A1 discloses a bidet apparatus with movable water pipe. In these documents, water pushes tube out of said housing by its pressure. Then, water flows out of said tube. When there is no water pressure, said spring pushes said tube back to its original position.

Patent document with number WO 2006040546 A1 discloses a pressure vessel for liquid and a toilet receptacle. Said pressure vessel comprises a substantially non-elastic membrane which divides the body into a liquid chamber for receiving liquid under pressure from a source and a gas chamber for containing gas. Said membrane is movable by the liquid under pressure entering the liquid chamber so as to compress the gas. Said liquid chamber comprises an outlet, through which the liquid can be driven by pressure in the gas chamber acting against the membrane. Said pressure vessel can be used for flushing the toilet receptacle as exemplified in FIGS. 13-17 of said document. In that embodiment, a device having a part which is movable to a position for flushing the toilet receptacle and being in connection with the pressure vessel is used. The device is provided in a cavity which is closed by a concealing flap and a protective lip. The device comprises a cylinder, an outer piston moving inside the cylinder, an inner piston moving in the outer piston, a flushing head connected with the inner piston, a helical spring provided between the cylinder and the outer piston and another helical spring provided between the inner piston and the outer piston. The liquid coming from the pressure vessel moves the cylinder, the outer piston and the inner piston through the toilet receptacle. During this movement flushing head pushes the flap and rotates it around a fixing axis and then flushing process is carried out. When the liquid coming from the pressure vessel is cut off, the cylinder, the outer piston and the inner piston moves into the cavity due to the springs and the flap comes to a closed position which prevents the urine entering from the cavity.

Patent document with number WO 9615331 A1 discloses a toilet seat-bidet assembly including a toilet, seat mounted for pivoting movement about a rear hinge; the toilet seat including a flow control means; water heating means; thermostat, means; water diverting means; front and rear nozzles; air blower and heating means for heating the air and a friction, hinge with slow damping downward pivoting movement with effortless upper pivoting movement. Said assembly also comprises a door for closing said rear nozzle.

### BRIEF SUMMARY OF THE INVENTION

In the bidet apparatus of the invention, the bidet pipe is hidden and comes out by water pressure only when it is used. While the pipe comes out, the cover covering outlet of the pipe is opened by pushing force of the pipe. Meanwhile, splashing of water is prevented since water has not left the bidet pipe yet. As a result of forward movement of the pipe, the cover is released from end of the pipe and then, washing water comes out of the pipe and is used in a safe way. Therefore, said cover both protects water outlet and ensures a safety use without directly contacting with water thanks to structure of apparatus.

The bidet apparatus of the invention structurally comprises one main shell in form of a tube; one rear shell, which is provided at rear side of the bidet apparatus, in the form of a tube; one bidet pipe which comprises a rear surface, a water outlet provided at the front side of the pipe and an inner space for water passage, which moves out of the main shell by moving in forward direction via water pressure exerted on the rear surface and which moves back via pressure of a spring within the main shell and via water cut-off; at least one sealing in the form of a ring which is situated in one channel provided at rear side of the bidet pipe; one inner surface provided on said rear shell, wherein water is prevented passing said sealing when said sealing is in this inner surface; an another inner surface which is provided on the main shell, which has a larger section with respect to the inner surface provided on the rear shell such that water passage between the sealing and the inner surface provided on said main shell is allowed; at least one water passage hole which transmits water passing around the sealing to the inner space of the pipe when the sealing reaches the inner surface provided on the main shell and which is on side surface of the pipe; a water inlet at the back side of said rear shell; one connection surface formed as screw passage within the rear shell. In the apparatus, there is provided at least one cover, which is provided in front of the water outlet of the pipe, which is fixed to the main shell by means of a hinge in the front portion of said main shell, and which is opened by rotating after being pushed by the bidet pipe that moves forward and at least one water draining channel on said connection surface.

### OBJECTIVE OF THE INVENTION

An aim of the invention is to form one bidet apparatus the bidet pipe of which moves out only when it is used,

Another aim of the invention is to form one cover which protects water outlet of said bidet apparatus.

Yet another aim of the invention is to form a bidet apparatus comprising a bidet pipe which moves out by means of the water pressure and which moves back via water cut off.

Another aim of the invention is to form a bidet apparatus that drains water in the apparatus while the bidet pipe is moving back for preventing water passage into the bidet pipe.

The other aim of the invention is to provide an effectively operating bidet apparatus.

A further aim of the invention is to ensure that said apparatus is easy and cheap to mount, and is safe and hygienic.

### BRIEF DESCRIPTION OF THE DRAWINGS

The bidet apparatus of the invention is illustrated in annexed figures, wherein;

FIG. 1 is general perspective view of the bidet apparatus.

FIG. 2 is perspective sectional view of the bidet apparatus.

FIG. 3 is sectional view of the bidet apparatus in closed position.

FIG. 4 is sectional view of the bidet apparatus in open position.

All the parts illustrated in figures are individually assigned a reference numeral and the corresponding terms of these numbers are listed below.
Bidet apparatus (A)
Main shell (1)
Rear shell (2)
Bidet pipe (3)
Cover (4)
Spring (5)
Cover sealing (6)
O-ring (7)
Sealing (8)
Outer shell (9)
Sealing (10)
Spring leaning surface (11)
Inner surface (12)
Sealing grooves (13)
Front surface (14)
Connection surface (15)
Connection surface (16)
Front portion (17)
Inner surface (21)
Water inlet (23)
Connection surface (23)
Draining channel (24)
Connection surface (25)
Rear surface (31)
Rabbet (32)
Sealing bedding channel (33)
Water passage hole (34)
Inner space (35)
Water outlet (36)
Outer surface (37)
Cover hinge (41)
Inner surface of sealing (81)
Outer surface of sealing (82)
Connection surface (91)

### DETAILED DESCRIPTION OF THE INVENTION

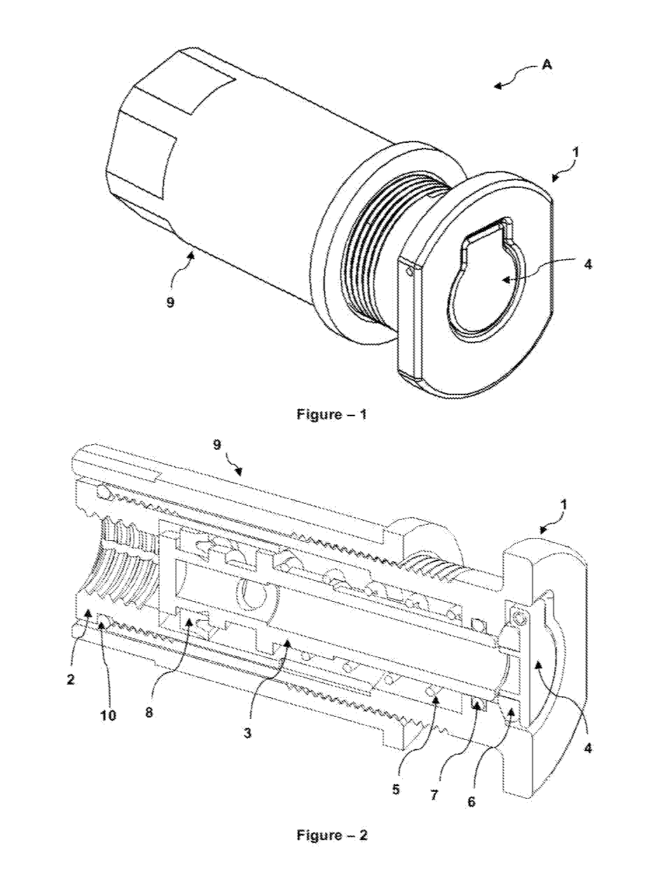

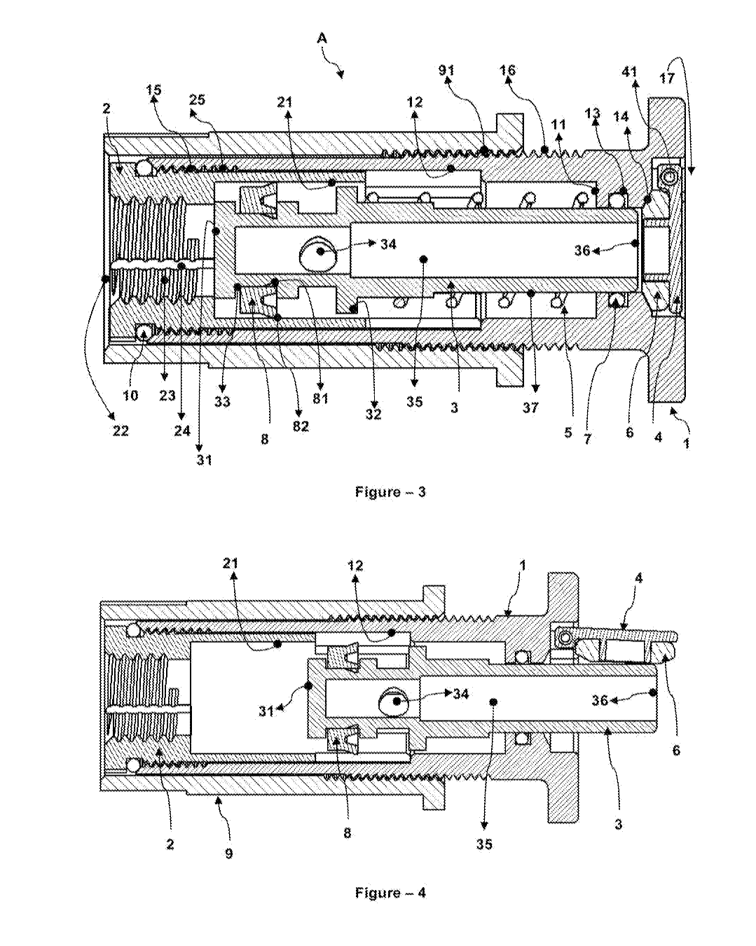

The bidet apparatus (A) of the invention illustrated in FIGS. 1-4 comprises one main shell (1) in form of tube; one bidet pipe (3) having the feature of moving in forward/backward, directions within the main shell (1); at least one cover (4), which is situated in front of the main shell (1) and can be opened or closed according to movement of the bidet pipe (3).

The bidet pipe (3) can move in forward direction by water pressure exerted on a rear surface (31) of the pipe (3). Thanks to this movement the bidet pipe (3) moves in forward direction and extends towards outside of the main shell (1). And then, the bidet pipe (3) moves in backward direction within the main shell (1) via water cut-off water and via pressure of a spring (5) within the main shell (1).

Said spring (5) is positioned between a rabbet (32), which is provided in the middle portion of the bidet pipe (3) and which extends outward radially, and one leaning surface (11) within the main shell (1). While the bidet pipe (3) moves in forward direction, the spring (5) is pressed between the said rabbet (32) and the leaning surface (11). After water is cut off, the pressed spring (5) pushes back, the bidet pipe (3) and restores its previous position within the main shell.

There is provided at least one sealing (8) in form of a ring surrounding the bidet, pipe (3) at rear side of the pipe (3). The sealing (8) here is situated in one channel (33) and serves for preventing water leakage between the inner surface (81) of the sealing (8) and the pipe (3). Outer surface (82) of the sealing (8) is in contact with one inner surface (21) (said inner surface (21) may belong to rear shell (2) and/or main shell (1) and is illustrated as being in connection with rear shell (2) in figures) and prevents water leakage between the inner surface (21) and the outer surface (82). In other words, the sealing (8) prevents water leakage in front and hack sides through the bidet pipe (3) and said inner surface (21).

In front side of the inner surface (21), there is another inner surface (12) (said inner surface (12) may belong to rear shell (2) and/or main shell (1) and it is illustrated as being in connection with the main shell (1) in figures), which has a larger section with respect to the inner surface (21). When the bidet pipe (3) moves towards front side (in forward direction), the sealing (8) moves away from the inner surface (21) with which it contacts and then, when it reaches the other inner surface (12) mentioned here, water which pushes the bidet pipe (3), reaches front side of the sealing (8) by passing around of the sealing (8). After water passes through at least one water passage hole (34) provided in side surface of the pipe (3), it reaches an inner space (35) of the pipe (3) and flows out through a water outlet (36) of the pipe (3).

There is provided at least one sealing channel (13) in front portion of the main shell (1). Leaking of water into or outside of the pipe (3) through an outer surface (37) thereof is prevented by means of at least one o-ring (7) (or sealing) positioned herein which surrounds die outer surface (37) of the pipe (3).

While the bidet pipe (3) is in completely closed (in backmost position) position, it pushes the cover (4), provided in front of water outlet (36) of the pipe (3), forward during its forward movement. Since the cover (4) is fixed to the main shell (1) via one hinge (41) in a front portion (17) of said shell (1), it is opened by rotating. During this opening process, water comes from the bidet pipe (3) only when the sealing (8) reaches said inner surface (12). Meanwhile the pipe (3) protrudes further and ensures that the cover (4) is further opened. Therefore, the cover (4) is opened only by movement of the pipe (3) and during this opening process; coming of water from the pipe (3) is prevented and that water does not contact with the cover (4) accordingly. Consequently, while the cover (4) is opened, water does not splash after it hits the cover (4). Following the closing movement of the bidet pipe (3), the cover (4) is closed again by means of at least one spring (not shown in figures) in the hinge (41) portion. (In the event that the hinge (41) is above, as an alternative, it is possible that the cover is closed (without using a spring) thanks to its own weight).

It is possible to prevent water leakage into or out of the pipe (3) thanks to at least one sealing (6), which is situated (so as to be present between the cover (4) and the pipe (3)) in the inner portion the cover (4) so as to move together with the cover (4). To this end, the sealing (6) ensures water tightness by leaning on a front surface (14), through which the pipe (3) protrudes, of the main shell (1).

The apparatus (A) may consist of main shell (1), rear shell (2) and outer shell (9), which are independently removable and engageable to each other with the aim of making the bidet apparatus (A) to be easy to produce and mount. At least two of these shells (1, 2, 9) can also be produced in a single piece.

The rear shell (2) of the apparatus (A) (it is provided at rear side of the apparatus (A)) is in form of a tube like the main shell (1) and has one water inlet (22) at its rear side. Water coming from installation (not shown in figures) enters this inlet (22) and exerts pressure on the rear surface (31) of the pipe (3) and pushes the pipe (3) in forward direction. In the rear shell (2) there is provided one connection surface (23), which is formed as a screw passage. Thanks to said surface (23), the rear shell (2) can be fixed to an installation member (not shown in figures) by turning for the aim of mounting. At least one draining channel (24) formed on said surface (23) is used in order to drain water (by means of a separate channel not shown in figures) remaining in the rear side of the pipe (3) while the pipe (3) moves back. Since moving out of the pipe (3) from the main shell (1) is provided by the water pressure coming from the installation and moving back of the pipe (3) is ensured by the spring (5) and water cut off; to move back the pipe (3) the water remained at the rear side of the pipe (3) after water cut off should be drained for accurate operation of the spring (5). For that purpose, the remaining water at the rear side of the pipe (3) is drained by means of the draining channel (24) provided on said connection surface (23). Moreover, by this way, the remaining water in the rear side of the pipe (3) can easily be drained and cannot enter inside of the bidet apparatus (A) (inside inner surface of the bidet apparatus (A)) when the pipe (3) is moving back. Also, since draining channel (24) is provided on the connection surface (23) provided on the rear shell (2), during moving back of the pipe (3), the pipe (3) and the sealing (8) provided at the rear side of the pipe (3) do not block the water passage through the draining channel (24), and effective drainage of the water remained at the rear side of the pipe (3) is able to be ensured; and therefore the bidet apparatus (A) operates effectively by ensuring the last moving back of the pipe (3).

There are provided connection surfaces (15,25) in form of screw passages in the inner surface of the main shell (1) and the outer surface of the rear shell (2) in order to fix the rear shell (2) into the main shell (1); and also these two shells (1, 2) can be fixed to each other by turning movement. Water tightness between these two shells (1, 2) is ensured by means of a sealing (10) provided between them. Connection surfaces (16, 91) in form of screw passages within the outer shell (9) and outside of the main shell (1) allows the main shell (1) and the outer shell (9) to be fixed each other by turning movement. The outer shell (9) is provided outside of the main shell (1) and is used for the aim of both protecting the apparatus (A) and mounting the apparatus (A) in desired place.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A bidet apparatus, comprising one main shell in the form of a tube; one rear shell, which is provided at rear side of the bidet apparatus, in the form of a tube; one bidet pipe which comprises a rear surface, a water outlet provided at the front side of the pipe and an inner space for water passage, which moves out of the main shell by moving forward via water pressure exerted on the rear surface and which moves back via pressure of a spring within the main shell and via water cut-off; at least one sealing in the form of a ring which is situated in one channel provided at rear side of the bidet pipe; one inner surface provided on said rear shell, wherein water is prevented passing said sealing when said sealing is in this inner surface; an another inner surface which is provided on the main shell, which has a larger section with respect to the inner surface provided on the rear shell such that water passage between the sealing and the inner surface provided on said main shell is allowed; at least one water passage hole which transmits water passing around the sealing to the inner space of the pipe when the sealing reaches the inner surface provided on the main shell and which is on side surface of the pipe; a water inlet at the back side of said rear shell; one connection surface formed as screw passage within the rear shell characterized in that said bidet apparatus comprises:
at least one cover, which is provided in front of the water outlet of the pipe, which is fixed to the main shell by means of a hinge in a front portion of said shell, which is opened by rotating after being pushed by the bidet pipe that moves forward;
at least one water draining channel on said connection surface.

13. A bidet apparatus according to claim 12, characterized in that it comprises at least one spring which closes the cover back and which is in the hinge portion.

14. A bidet apparatus according to claim 12, characterized in that it comprises at least one sealing, which is situated in an inner portion of the cover so as to move together with the cover, which leans on a front surface, from which the pipe comes out, of the main shell while the cover is in closed position.

15. A bidet apparatus according to claim 12, characterized in that it comprises at least one o-ring, which is provided in at least one sealing channel in the front portion of the main shell and surrounds all around an outer surface of the pipe.

16. A bidet apparatus according to claim 12 characterized in that it comprises connection surfaces which are formed as screw passages provided on the inner surface of the main shell and on the outer surface of the rear shell in order to fix the rear shell into the main shell.

17. A bidet apparatus according to claim 16, characterized in that it comprises at least one sealing between the main shell and the rear shell.

18. A bidet apparatus according to claim 12, characterized in that it comprises one outer shell which is provided outside of the main shell.
